(19) United States
(12) Patent Application Publication
(10) Pub. No.: US 2016/0026932 A1
(43) Pub. Date: Jan. 28, 2016

(54) Intelligent System with Integrated Representation Learning and Skill Learning

(71) Applicant: Carnegie Mellon University, Pittsburgh, PA (US)

(72) Inventors: Nan Li, Pittsburgh, PA (US); William R. Cohen, Pittsburgh, PA (US); Kenneth R. Koedinger, Pittsburgh, PA (US); Noboru Matsuda, Pittsburgh, PA (US)

(21) Appl. No.: 14/808,795

(22) Filed: Jul. 24, 2015

Related U.S. Application Data
(60) Provisional application No. 61/999,363, filed on Jul. 24, 2014.

(51) Int. Cl. G06N 99/00; G09B 19/00; G09B 19/02; G09B 7/00; G09B 19/06

(52) U.S. Cl. CPC G06N 99/005; G09B 7/00; G09B 19/06; G09B 19/025; G09B 19/00

(57) ABSTRACT

A computer-implemented method includes, in one aspect, obtaining data specifying one or more expressions for a problem to be solved and an action that changes a state of the problem when applied to the one or more expressions, identifying one or more features of the one or more expressions, identifying a precondition for applying the action that changes the state of the problem, identifying a sequence of operator functions, and generating a production rule based on the identified one or more features, the identified precondition, and the identified operator function.

### CROSS REFERENCE TO RELATED APPLICATIONS

This application claims the benefit of priority under 35 U.S.C. §119(e) to provisional U.S. Patent Application No. 61/999,363 filed on Jul. 24, 2014, the entire contents of which are hereby incorporated by reference.

### STATEMENT REGARDING FEDERALLY SPONSORED RESEARCH AND DEVELOPMENT

This invention was made with partial government support under the National Science Foundation Grant Number SBE-0836012. The government has certain rights to this invention.

### BACKGROUND

The present disclosure relates to creating intelligent systems by demonstration rather than by programming.

In recent years, there has been an interest for leveraging online platforms for education. Examples of such platforms include Khan Academy and Stanford online courses. In order to provide better online learning experiences, educators and researchers have worked to develop personalized interactive tutoring systems, such as cognitive tutors, that teach individual students according to their abilities, learning styles, and other factors. However, building such tutoring systems may require artificial intelligence programming skills and cognitive psychology expertise. Additionally, building such tutoring systems may require manual encoding of prior domain knowledge, which may be time-consuming and error-prone.

### SUMMARY

The present disclosure describes an intelligent system that inductively learns skills to solve problems from demonstrated solutions and from problem solving experience with minimal knowledge engineering required. The intelligent system can be integrated into authoring tools for cognitive tutors. The intelligent system extends programming by demonstration techniques. It does so by adding machine learning mechanisms for inducing representations from unlabeled examples and for refining production roles based on feedback. The system allows the end-users to create intelligent tutoring systems by teaching the computer rather than by programming.

In one aspect, a method includes obtaining data specifying one or more expressions for a problem to be solved and an action that changes a state of the problem when applied to the one or more expressions; identifying, by one or more processors, one or more features of the one or more expressions based on stored grammar rules and further based on features of stored positive training problems that are associated with positive feedback; identifying, by the one or more processors, a precondition for applying the action that changes the state of the problem, with identification of the precondition based on the positive training problems, negative training problems associated with negative feedback, and the identified one or more features of the one or more expressions; identifying, by the one or more processors, a sequence of operator functions based on the identified one or more features, the action that changes the state of the problem, and the positive training problems; and generating, by the one or more processors, a production rule based on the identified one or more features, the identified precondition, and the identified operator function.

Implementations of the disclosure can include one or more of the following features. The problem to be solved can be in a math, science, or language learning domain. Identifying the one or more features of the one or more expressions may include generating a parse tree for an expression using the stored grammar rules, with the parse tree comprising one or more nodes for one or more respective features of the expression, and identifying the one or more features of the one or more expressions based on the generated parse tree. Identifying the precondition may include identifying the precondition based on positions of the one or more nodes for the one or more respective features of the expression. Identifying the one or more features of the one or more expressions may include identifying an intermediate symbol in a rule set of a probabilistic context free grammar, the intermediate symbol corresponding to a highest number of the stored positive training problems, and extracting the one or more features associated with the intermediate symbol. Identifying the sequence of operator functions may include searching for a composed sequence of operator functions from a stored set of operator functions using iterative-deepening depth-first search to identify the composed sequence of operator functions that has a smallest number of operator functions that includes the identified one or more features and the action that changes the state of the problem. Generating the production rule based on the identified precondition may include generating a set of tests pertaining to the identified one or more features for determining whether the precondition is satisfied. The method may include determining a current state of another problem, identifying the generated production rule from a stored set of production rules based on the current state of the other problem, and providing a proposed action for solving the other problem based on the generated production rule. The method may include receiving feedback indicating that the proposed action is correct for solving the other problem, and storing the current state and the proposed action as a positive training problem. The method may include receiving feedback indicating that the proposed action is incorrect for solving the other problem, and storing the current state and the proposed action as a negative training problem.

All or part of the foregoing may be implemented as a computer program product including instructions that are stored on one or more non-transitory machine-readable storage media, and that are executable on one or more processing devices. All or part of the foregoing may be implemented as an apparatus, method, or electronic system that may include one or more processing devices and memory to store executable instructions to implement the stated functions.

The subject matter described in this specification may be implemented to realize one or more of the following potential advantages. An intelligent system that models automatic knowledge acquisition without domain-specific prior knowledge may be helpful both in reducing the effort in knowledge engineering intelligent systems and in advancing the cognitive science of human learning. The system may reduce the time needed and the error involved with manual encoding of a nontrivial amount of domain-specific prior knowledge. The system may use a human-like learning agent, which may be useful since the system may be able to predict errors made by students when interacting with an automatic tutor. Moreover, building a system that simulates human learning of math and science could potentially benefit both artificial intelligence, by advancing the goal of creating human-level intelligence, and learning science, by contributing to the understanding of human learning. With representation learning, the system can perform at a level comparable or better to when it is given manually-constructed prior knowledge, but without the effort that may be required to create such prior knowledge. The system can be used to discover student models that may predict human student behavior. The student models can be used to gain insights into human learning.

The details of one or more implementations are set forth in the accompanying drawings and the description below. While specific implementations are described, other implementations exist that include operations and components different than those illustrated and described below. Other features, objects, and advantages will be apparent from the description, the drawings, and the claims.

### BRIEF DESCRIPTION OF THE FIGURES

FIG. 1 is a block diagram of an example of an intelligent system.

FIG. 2 shows a screenshot of an example of a user interface of the intelligent system learning to solve algebra equations.

FIG. 3 shows an example of a production rule learned by the intelligent system.

FIG. 4 shows an example of a correct parse tree for −3x.

FIG. 5 shows an example of an incorrect parse tree for −3x.

FIG. 6 shows an example of an original production rule and a corresponding extended production rule.

FIG. 7 shows an example of an extended perceptual hierarchy.

FIG. 8 shows an example of a parse tree for the fraction ⅗.

FIG. 9 shows an example of a parse tree for 1 mol COH₄.

FIG. 10 is a flowchart of an example of a process for generating a production rule.

FIG. 11 is a flowchart of an example of a process for learning a production rule.

FIG. 12 is a block diagram of an example of a network environment including an intelligent system.

FIG. 13 is a block diagram of examples of components of the network environment of FIG. 12.

### DETAILED DESCRIPTION

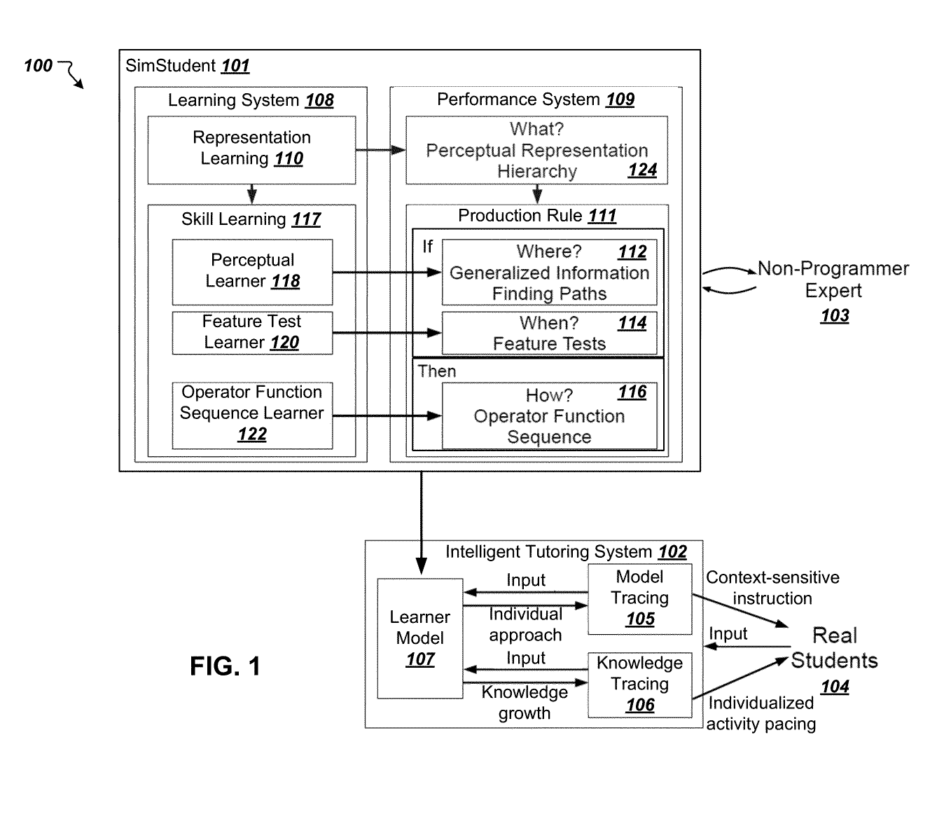

FIG. 1 is a block diagram of an example of an intelligent system 100. The intelligent system 100 includes a machine-learning agent 101, referred to as SimStudent, that inductively learns skills to solve problems or to perform tasks from demonstrated solutions and from problem solving experience. SimStudent 101 learns problem-solving skills by examples and by feedback on performance. SimStudent 101 is an extension of programming by demonstration using a variation of a version space algorithm, inductive logic programming, and iterative-deepening depth-first search as underlying learning techniques. SimStudent 101 may be generated with minimal knowledge engineering required. SimStudent 101 may be applied to various domains such as multicolumn addition, fraction addition, equation solving, stoichiometry, article selection, and language learning. SimStudent 101 can be integrated into authoring tools for an intelligent tutoring system 102, so that an end-user such as a non-programming expert 103 can create the intelligent tutoring system 102 by demonstration rather than by programming.

The intelligent tutoring system 102 can provide context-sensitive and personalized instructions based on interactions of real students 104 with the tutoring system 102. Given a problem selected by the tutoring system 102, a real student 104 tries to solve the problem by providing a step-by-step solution to the tutoring system 102. The tutoring system 102 sends the input provided by the student to two intelligent instruction selection mechanisms, a model tracing component 105 and a knowledge tracing component 106.

The model tracing component 105 gives the student's input to a learner model 107. The learner model 107 is a system that can solve problems in various ways as human students can. Thus, the learner model 107 produces the student's individual approach in solving the problem. Based on this information from the learner model 107, the model tracing component 105 generates context-sensitive instructions to the student 104. For example, if the student 104 is given a problem 3(2x−5)=9, the learner model 107 shows that there are two correct ways of solving the problem: 1) distribute the left hand side (i.e., 6x−15=9), or 2) divide both sides by 3 (i.e., 2x−5=3). The tutoring system 102 provides different hint messages for these two solutions.

The tutoring system 102 can select problems for a human student 104 based on the assessment of the student's knowledge growth. More specifically, the knowledge tracing component 106 in the tutoring system 102 asks the learner model 107 to assess the chance of the human student 104 in knowing a specific skill, and then chooses the problems that will focus more on the skills that the student 104 has not mastered.

SimStudent 101 can be used to automatically discover learner models for the learner model component 107. SimStudent 101 includes a learning system 108 and a performance system 109. The output of SimStudent 101 is represented as production rules 111. Each production rule 111 corresponds to one knowledge component (KC) in the performance system 109. A production rule 111 consists of three parts, the “where” part 112, the “when” part 114, and the “how” part 116. Each part is acquired by one of the components of a skill learning component 117 in the learning system 108. For example, the “where” part 112 is acquired by the perceptual learner 118. The “when” part is acquired by the feature test learner 120. The “how” part is acquired by the operator function sequence learner 122.

The learning system 108 includes a representation learning component 110 that acquires representations of the problems in terms of deep features automatically with only domain-independent knowledge (e.g., what is an integer) as input. The output of the representation learning component 110 generates a perceptual representation hierarchy 124 as SimStudent's working memory, which is used in the performance system to match against the production rules. For skill learning, the representation learning component 110 acquires and extends the perceptual representation hierarchy 124 to replace the originally manually-constructed prior knowledge needed for perceptual learner 118 and the operator function sequence learner 122. The representation learning component 110 also automatically generates feature predicates as the prior knowledge for the feature test learner 120.

Before learning, SimStudent 101 is given a set of feature predicates and a set of operator functions as prior knowledge. A feature predicate is a boolean function that describes relations among objects in the domain. For example, (has- coefficient −3x) means −3x has a coefficient. SimStudent 101 uses these feature predicates to understand the state of the given problems.

Operator functions specify basic functions (e.g., add two numbers, get the coefficient) that SimStudent 101 can apply to aspects of the problem representation. Operator functions are divided into two groups, domain-independent operator functions and domain-specific operator functions.

Domain-independent operator functions can be used across multiple domains, and may be simpler (like standard operations on a programming language) than domain-specific operator functions. Examples of domain-independent operator functions include adding two numbers (add 1 2) or copying a string (copy −3x). These operator functions are not only useful in solving equations, but can also be used in other domains such as multicolumn addition and fraction addition. Because these domain-general operator functions are involved in domains that are acquired before algebra, real students may know them prior to algebra instruction. Because these domain-general operator functions can be used in multiple domains, there is a potential engineering benefit in reducing or eliminating a need to write new operator functions when applying SimStudent 101 to a new domain.

Domain-specific operator functions, on the other hand, are more complicated functions, such as getting the coefficient of a term (coefficient −3x) or adding two terms. Performing such operator functions may imply some domain expertise that real students are less likely to have. Domain-specific operator functions may require more knowledge engineering or programming effort than domain-independent operator functions. For example, compare the “add” domain-independent operator function with the “add-term” domain-specific operator function. Adding two numbers is one step among the many steps in adding two terms together (i.e., parsing the input terms into sub-terms, applying an addition strategy for each term format, and concatenating all of the sub-terms together).

From a learner modeling perspective, beginning students may not know domain-specific operator functions. Since real students entering a course may not have substantial domain-specific or domain-relevant prior knowledge, it may not be realistic in a model of human learning to assume this knowledge is given rather than learned. For example, students learning about algebra may not know beforehand what a coefficient is, or what the difference between a variable term and a constant term is, and thus providing such operator functions to SimStudent 101 may produce learning behavior that is distinctly different from human students. An intelligent system that models automatic knowledge acquisition with a small amount of prior knowledge may be helpful both in reducing the effort in knowledge engineering intelligent systems and in advancing the cognitive science of human learning.

A list of feature predicates and operator functions that can be provided to SimStudent 101 for fraction addition are shown in the table below. The provided operator functions in Table 1 below are basic skills that are used in math domains.

TABLE 1

| Feature predicates | Operator functions |
|---|---|
| is-greater-number(?val0, ?val1) | copy(?val0) |
| is-coprimed(?val0, ?val1) | greater-number(?val0, ?val1) |
| is-multiple-of(?val0, ?val1) | add(?val1, ?val1) |
| | subtract(?val0, ?val1) |
| | multiply(?val0, ?val1) |
| | divide(?val0, ?val1) |
| | least-common-multiple(?val0, ?val1) |

Note that operator functions are different from operators in traditional planning systems. Operator functions have no explicit encoding of preconditions and may not produce correct results when applied in context. Thus, SimStudent 101 is different from traditional planning algorithms, which can be limited to performing speed-up learning. SimStudent 101 engages in knowledge-level learning and inductively acquires complex reasoning rules. These rules are represented as production rules.

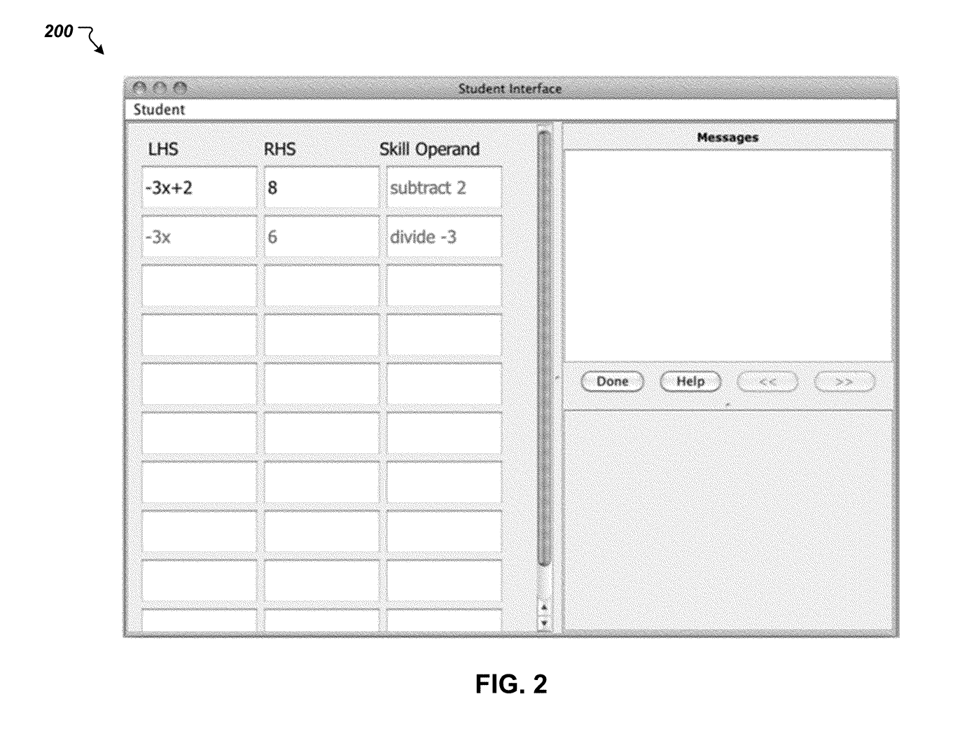

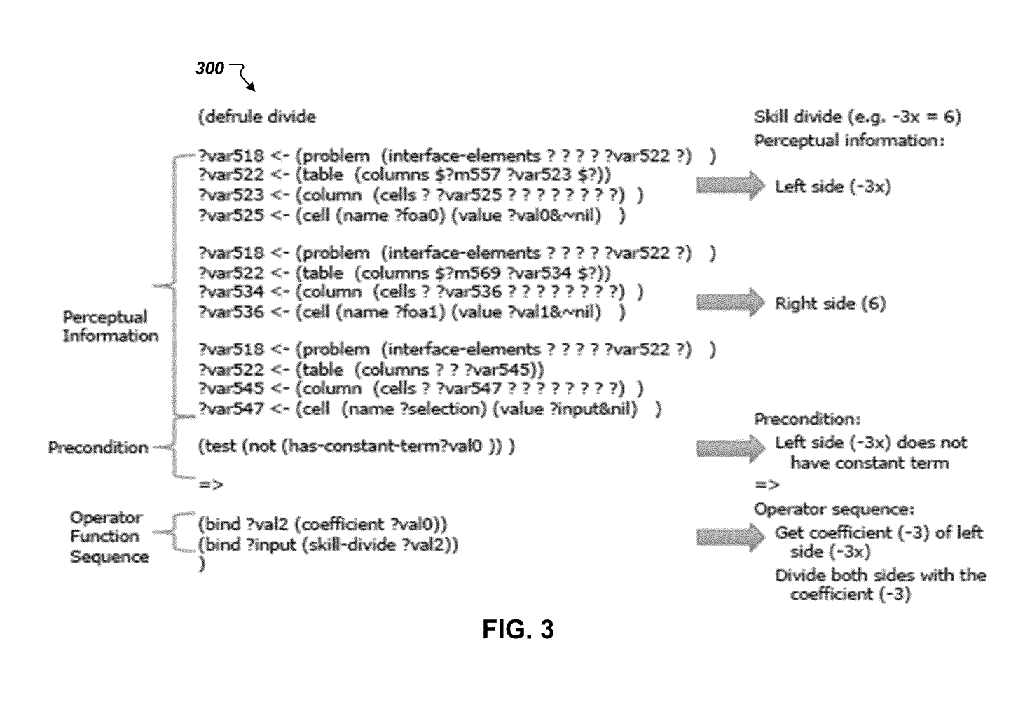

FIG. 2 shows a screenshot of an example of a user interface 200 of SimStudent 101 learning to solve algebra equations. FIG. 3 shows an example of a production rule 300 learned by SimStudent 101. A simple English description of the production rule 300 is shown on the right hand side of FIG. 3. As shown in FIG. 1, a production rule indicates “where” to look for information in the interface (perceptual information), “how” to change the problem state (an operator function sequence), and “when” to apply a rule (a set of features indicting the circumstances under which performing the “how” part will be useful).

For example, the production rule 300 to “divide both sides of −3x=6 by −3” shown in FIG. 3 can be read as “given a left-hand side (i.e., −3x as shown in FIG. 2) and a right-hand side (i.e., 6 as shown in FIG. 2) of an equation, when the left-hand side does not have a constant term, then get the coefficient of the term on the left-hand side and write ‘divide’ followed by the coefficient.” The perceptual information part represents hierarchical paths to identify useful information from the GUI as shown in FIG. 2. The precondition (just before “=>” in FIG. 3) includes a set of feature tests representing desired conditions in which to apply the production rule. The last part (after “=>” in FIG. 3) is the operator function sequence which computes what to output in the GUI.

Referring again to FIG. 1, the working memory of SimStudent 101 is represented as the perceptual representation hierarchy 124. For example, the elements in the interface shown in FIG. 2 can be organized in a directed graph. The perceptual representation hierarchy 124 in this case consists of a table node, the table node has columns as children, and each column has multiple cells as children. During execution, SimStudent 101 updates its working memory with inputs from the environment as a hierarchy, and matches this information against the acquired production rules. The “where” part finds the useful information from this hierarchy. Next, the “when” part uses the useful information to decide which production rule to fire. The selected production rule will generate an action that SimStudent 101 is going to execute in the world determined by the “how” part of the production rule.

As shown in FIG. 1, SimStudent 101 uses three different learning components to acquire the three parts of a production rule 111, where each learning component models one aspect of problem-solving skill acquisition. The first component is the perceptual learner 118 that learns the “where” part 112 of the production rule 111 by finding paths to identify useful information in the perceptual representation hierarchy 124. The percepts specified in the production rule are cells associated with the sides of the algebra equation, which are Cell 11 and Cell 21 in the example shown in FIG. 2. Hence, the task of the perceptual learner 118 is to find the right paths in the tree to reach the specified cell nodes. There are two ways to reach a percept node in the interface: 1) by the exact path to its exact position in the tree, or 2) by a generalized path to a set of GUI elements that may have a specific relationship with the GUI element where the next step is entered (e.g., cells above next step). A generalized path has one or more levels in the tree that are bound to more than one node. For example, a cell in the second column and the third row, Cell 23, can be generalized to any cell in the second column, Cell 2?, or any cell in the table, Cell ??. In the example shown in FIG. 3, the production rule has an over-specific “where” part 112 that produces a next step only when the sides of the current step are in row two. The perceptual learner 118 searches for the least general path in the version space formed by the set of paths to training examples. This process may be done by a brute-force depth-first search. For example, if only given the example −3x=6 in row two, the production rule learned as shown in FIG. 3 has an over-specific “where” part. If given more examples in other rows (e.g., 4x=12 in row three), the where-part will be generalized to any row in the table.

The second part of the learning mechanism is the feature test learner 120 that learns the “when” part 114 of the production rule 111 by acquiring the precondition of the production rule 111 using the given feature predicates. The acquired preconditions should contain information about both applicability (e.g., getting a coefficient is not applicable to the term 3x+5) and search control (e.g., it is not preferred to add 5 to both sides for problem −3x=6). The feature test learner may utilize FOIL, an inductive logic programming system that learns Horn clauses from both positive and negative examples expressed as relations. FOIL can be used to acquire a set of feature tests that describe the desired situation in which to fire the production rule 111. For each production rule, the feature test learner 120 creates a new predicate that corresponds to the precondition of the rule 111, and sets it as the target relation for FOIL to learn. The arguments of the new predicate are associated with the percepts. Each training action record serves as either a positive or a negative example for FOIL based on the feedback provided by the tutor. For example, (precondition-divide ?percept1 ?percept₂) is the precondition predicate associated with the production rule named “divide”. A positive example for the production rule “divide” may be (precondition-divide −3x 6). The feature test learner 120 computes the truthfulness of all predicates bound with all possible permutations of percept values, and sends it as input to FOIL. Given these inputs, FOIL will acquire a set of clauses formed by feature predicates describing the precondition predicate.

The last component is an operator function sequence learner 122 that acquires the “how” part 116 of the production rule 111. For each positive example action record, the operator function sequence learner 122 takes the percepts, Rᵢ.percepts, as the initial state, and sets the step, Rᵢ.step, as the goal state. An operator function sequence explains a percepts-step pair, <Rᵢ.percepts, Rᵢ.step>, if SimStudent 101 takes Rᵢ.percepts as an initial state and yields step, after applying the composed sequence of operator functions. For example, if SimStudent 101 first receives a percepts-step pair, <(2x, 2), (divide 2)>, both the operator function sequence that directly divides both sides with the right-hand side (i.e., (bind ?output (divide 2))), and the sequence that first gets the coefficient, and then divides both sides with the coefficient (i.e., (bind ?coef (coefficient 2x ?coej)) (bind ?output (divide ?coej))) are possible explanations for the given pair. Since we have multiple example action records for each skill, it is not sufficient to find one operator function sequence for each example action record. Instead, the operator function sequence learner 122 attempts to find a sequence having the smallest number of operator functions that explains all of the <percepts, step> pairs using iterative-deepening depth-first search within some depth-limit. As in the above example, since (bind ?output (divide 2)) is shorter than (bind ?coef (coefficient 2x ?coej)) (bind ?output (divide ?coef)), the operator function sequence learner 122 will learn this operator function sequence as the “how” part 116. Later, it meets another example, −3x=6, and receives another percepts-step pair, <(−3x, 6), (divide −3)>. The operator function sequence that divides both sides with the right-hand side is not a possible explanation any more. Hence, the operator function sequence learner 122 modifies the “how” part 116 to be the longer operator function sequence (bind ?coef (coefficient ?rhs)) (bind ?output (divide ?coef)).

During the learning process, given the current state of the problem (e.g., −3x=6 as shown in FIG. 2), SimStudent 101 attempts to identify an appropriate production rule that proposes a plan for the next step (e.g., (coefficient −3x ?coej) (divide ?coef)). If it finds one, it executes the plan, performs an action in the system interface, and waits for feedback from the human user (e.g., an author or a tutor). If the user provides positive feedback, SimStudent 101 continues to the next step. If not, SimStudent 101 records this negative feedback and may try again to identify an appropriate production rule. If SimStudent 101 does not find a production rule that generates a correct action, it requests a demonstration of the next step, which the user performs in the interface. SimStudent may use any negative feedback to modify existing production rules. It uses the next-step demonstration, if provided, to learn a new production rule.

In some implementations, the user is simulated by a hand-engineered cognitive tutor, which provides SimStudent 101 with feedback and next-step demonstrations as needed via an application programming interface (API). For each demonstrated step, the tutor specifies the following information: 1) perceptual information from a graphical user interface (GUI) showing where to find information to perform the next step (e.g., −3x and 6 for −3x=6 as shown in FIG. 2), 2) a skill label (e.g., divide) corresponding to the type of skill applied, 3) a next step (e.g., (divide −3) for problem −3x=6 as shown in FIG. 2). This simulates the limited information available to real students.

In the algebra example shown in FIG. 2, the full plan might be to first retrieve a coefficient and then to divide by it (e.g., (coefficient −3x ?coef) (divide ?coef)), but the tutor only demonstrates the final action (e.g., (divide −3)) to SimStudent 101. Taken together, the three pieces of information form an example action record indexed by the skill label, R=<label, <percepts, step>>. In the algebra example, an example action record is R=<divide, <(−3x, 6), (divide −3)>>. For each incorrect next step proposed by SimStudent 101, an example action record is also generated as a negative example.

During learning, SimStudent 101 typically acquires one production rule for each skill label, l, based on the set of associated (both positive and negative) example action records gathered up to the current step, Rₗ=(R₁, R₂, . . . , Rₙ) (where rᵢ.label=l). Although SimStudent 101 tries to learn one rule for each label, when a new training action record is added, SimStudent 101 might fail to learn a single rule for all example action records when the perceptual learner 118 cannot find one path that covers all demonstrated steps, or the operator function sequence learner 122 cannot find one operator function sequence that explains all records. In that case, SimStudent 101 learns a separate rule just for the last example action record. This breaking a single production rule into a pair of disjuncts effectively splits the example action records into two clusters. Later, for each new example action record, SimStudent 101 tries to acquire a rule for each of the example clusters plus the new example action record. If the new record cannot be added to any of the existing clusters, SimStudent 101 creates another new cluster. This clustering behavior can be used to discover models of student learning.

SimStudent 101 may be extended to support acquisition of deep features as representation learning by the representation learning component 110. The representation learning component 110 takes problem states (e.g., −3x=6) as input, and acquires perceptual representation hierarchies 124 of the problems. In algebra equation solving, the hierarchy 124 could be modeled as an unsupervised grammar induction problem given observational data (e.g., expressions in algebra). Expressions can be formulated as a context free grammar and deep features are modeled as non-terminal symbols in particular positions in a grammar rule.

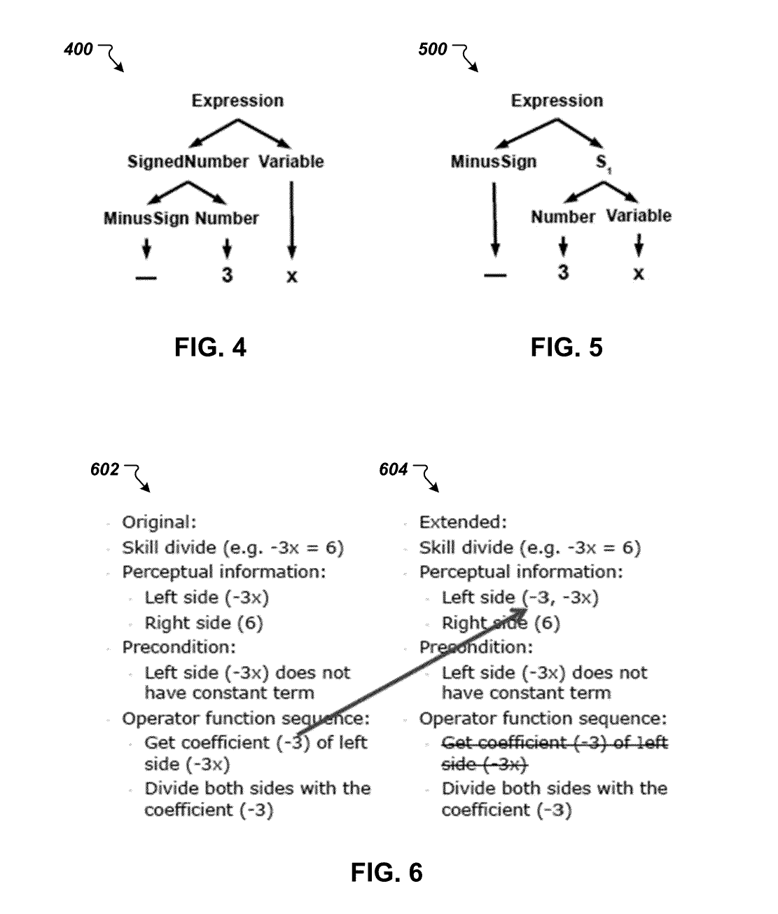

Viewing representation learning tasks as grammar induction provides a general explanation of how experts acquire perceptual chunks and explanations for specific novice errors. For example, some novice errors may be the result of acquiring the wrong grammar for the task domain. Using −3x as an example, the correct grammar produces the correct parse tree 400 as shown in FIG. 4. A novice, however, may acquire different grammar rules (e.g., because of plausible lack of experience with negative numbers) and these result in the incorrect parse tree 500 as shown in FIG. 5. In FIG. 5, instead of grouping “−” and “3” together, this grammar groups “3” and “x” first, and thus mistakenly considers “3” as the coefficient. In fact, a common strategic error students make in a problem like −3x=12 is for the student to divide both sides by 3 rather than −3. Based on these observations, the representation learning component 110 can be built by extending an existing probabilistic context free grammar (pCFG) learner to support feature learning and transfer learning. The representation learning component 110 is domain general. It can support domains where student input can be represented as a string of tokens, and can be modeled with a context-free grammar (e.g., algebra, chemistry, natural language processing).

The input of the representation learning component 110 is a set of pairs such as <−3x, −3>, where the first element is the input to a feature extraction mechanism (e.g., coefficient), and the second is the extraction output (e.g., −3 is the coefficient of −3x). The output of the representation learning component 110 is a pCFG with a non-terminal symbol in one of the rules set as the target feature. The learning process contains two steps. The system first acquires the grammar using a suitable algorithm. After that, the representation learning component 110 tries to identify a non-terminal symbol in one of the rules as the target feature. To do this, the representation learning component 110 builds parse trees for all of the observation sequences, and picks the non-terminal symbol that corresponds to the most training records as the deep feature. To produce this output, the representation learning component 110 uses the pCFG learner to produce a grammar, and then searches for non-terminal symbols that correspond to the extraction output (e.g., the −3 in −3x). The process is done in three steps.

The representation learning component 110 first builds the parse trees for all of the observation sequences based on the acquired rules. For instance, in algebra, suppose we have acquired the pCFG shown in Table 2 below:

TABLE 2
Terminal symbols: -, x, 0, 1, 2, 3, 4, 5, 6, 7, 8, 9;
Non-terminal symbols: Expression, SignedNumber, Variable, MinusSign,
Number;
Expression → 0:33, [SignedNumber] Variable
Expression → 0:67, SignedNumber
Variable → 1:0, x
SignedNumber → 0:5, MinusSign Number
SignedNumber → 0:5, Number
Number → 0:091, Number Number
Number → 0:091, 0
Number → 0:091, 1
Number → 0:091, 2
Number → 0:091, 3
Number → 0:091, 4
Number → 0:091, 5
Number → 0:091, 6
Number → 0:091, 7
Number → 0:091, 8
Number → 0:091, 9
MinusSign → 1:0, -

The associated parse tree of −3x is shown in FIG. 4. Next, for each sequence, the representation learning component 110 traverses the parse tree to identify the non-terminal symbol associated with the target feature extraction output, and the rule to which the non-terminal symbol belongs. In this example, the non-terminal symbol is SignedNumber, the associated feature extraction output is −3, and the rule is Expression→1.0, SignedNumber Variable. For some of the sequences, the feature extraction output may not be generated by a single non-terminal symbol, which may happen when the acquired pCFG does not have the right structure. For example, the parse tree shown in FIG. 5 is an incorrect parse of −3x, and there is no non-terminal symbol associated with −3. In this case, no non-terminal symbol is associated with the target feature for the current sequence, and this sequence will not be counted towards the identification of the target feature. Last, the representation learning component 110 records the frequency of each symbol rule pair, and picks the pair that matches the most training records as the learned feature. For instance, if most of the input records match with SignedNumber in Expression→1.0, SignedNumber Variable, this symbol-rule pair will be considered as the target feature pattern.

After learning the feature, when a new problem comes, the representation learning component 110 will first build the parse tree of the new problem based on the acquired grammar. Then, the representation learning component 110 recognizes the subsequence associated with the feature symbol from the parse tree, and returns it as the target feature extraction output (e.g., −5 in −5x). This model presented so far learns to extract deep features in a mostly unsupervised way without any goals or context from SimStudent problem solving.

The representation learning component 110 can be extended to support transfer learning within the same domain and across domains. Different grammars sometimes share grammar rules for some non-terminal symbols. For example, both the grammar of equation solving and the grammar of integer arithmetic problems may contain the sub-grammar of signed number. The representation learning component 110 can be extended to transfer solutions to common sub-grammars from one task to another. The tasks can be either from the same domain (e.g. learning what is an integer, and learning what is a coefficient), or from different domains (e.g. learning what is an integer, and learning what is a chemical formula).

To model transfer learning, the representation learning component 110 can be extended to acquire pCFGs based on previously acquired knowledge. When the representation learning component 110 is given a new learning task, it first uses the known grammar to build parse trees for each new record in a bottom-up fashion, and stops when there is no rule that could further merge two parse trees into a single tree. The representation learning component 110 then acquires new grammar rules as needed. Having acquired the grammar for deep features, when a new problem is given to the system, the representation learning component 110 will extract the deep feature by first building the parse tree of the problem based on the acquired grammar, and then extracting the subsequence associated with the feature symbol from the parse tree as the target feature. The representation learning component 110 is capable of learning and extracting deep features without using them to solve problems.

SimStudent 101 is able to acquire production rules in solving complicated problems, but requires a set of operators given as prior knowledge. Some of the operators are domain-specific, and require expert knowledge to build them. As shown in FIG. 1, the representation learning component 110 is integrated into SimStudent 101 to remove the need of domain-specific feature extraction operator functions. The original perceptual representation hierarchy 124 with the hierarchical representations of the problems acquired by the representation learning component 110 is integrate into the operator function sequence learner 122. The feature extraction operator functions can then be removed from the prior knowledge, as they can now be automatically acquired by the operator function sequence learner 122 from the extended perceptual representation hierarchy 124.

FIG. 6 shows a comparison between an original production rule 602 acquired by a SimStudent without a representation learning component and the extended production rule 604 acquired by a SimStudent with a representation learning component. The coefficient of the left-hand side (i.e., −3) is included in the perceptual information part in the extended production rule 604. Therefore, the operator function sequence no longer needs the domain-specific operator, “get-coefficient”. To achieve this, the representation learning component is extended as described below.

Previously, the perceptual information encoded in production rules was associated with elements in the graphical user interface (GUI) such as text field cells in the algebra equation solving interface. This assumption limited the granularity of observation SimStudent could achieve. In fact, the deep features we have discussed previously are perceptual information obtained at a fine-grained level. Representing these deep perceptual features may enhance the performance of SimStudent, and may eliminate or reduce the need for authors/developers to manually encode domain-specific operator functions to extract appropriate information from appropriate parts of the perceptual input.

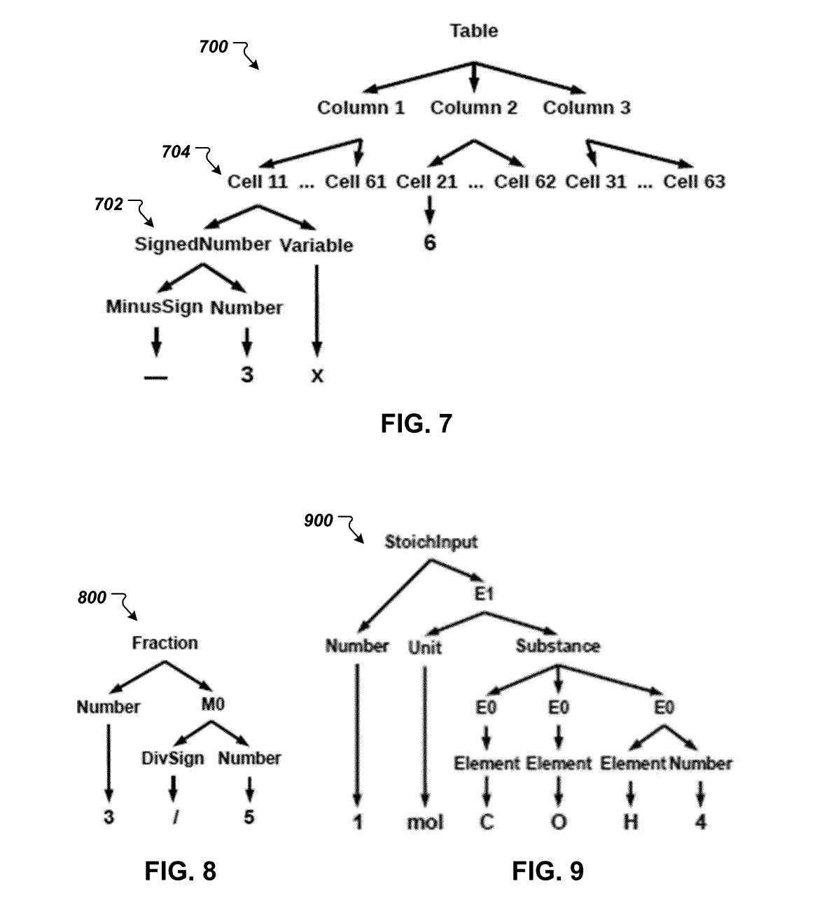

To improve perceptual representation, the percept hierarchy of GUI elements may be extended to further include the most probable parse tree for the content in the leaf nodes (e.g., text fields) by appending the parse trees as an extension of the GUI path leading to the associated leaf nodes. All of the inserted nodes are of type “subcell”. In the algebra example, this extension means that for cells that represent expressions corresponding to the sides of the equation, the extended SimStudent appends the parse trees for these expressions to the cell nodes. Using −3x as an example, the extended perceptual hierarchy 700 as shown in FIG. 7 includes a parse tree 702 for −3x as shown at the left side of FIG. 7 as a subtree connecting to the cell node 704 associated with −3x. With this extension, the coefficient (−3) of −3x is now explicitly represented in the perceptual hierarchy 700. If the extended SimStudent includes this subcell as a percept in production rules, as shown at the extended production rule 604 in FIG. 6, the new production rule does not need the first domain-specific operator function “coefficient”.

However, extending the percept hierarchy presents challenges to the original perceptual learner. First, since the extended subcells are not associated with GUI elements, the tutor can no longer be depended on to specify relevant perceptual input for SimStudent. Nor can all of the subcells simply be put in the parse trees as relevant perceptual information. If they were, the acquired production rules would contain redundant information that might hurt the generalization capability of the perceptual learner. For example, consider problems −3x=6 and 4x=8. Although both examples could be explained by dividing both sides with the coefficient, since −3x has eight nodes in its parse tree, while 4x has five nodes, the original perceptual learner will not be able to find one set of generalized paths that explain both training examples. Moreover, not all of the subcells are relevant percepts in solving the problem. Including unnecessary perceptual information into production rules could easily lead to computational issues. Second, since the size of the parse tree for an input depends on the input length, the assumption of fixed percept size made by the “where” learner no longer holds. In addition, how the inserted percepts should be ordered may not be immediately clear. To address these challenges, the original perceptual learner can be extended to support acquisition of perceptual information with redundant and variable-length percept lists.

To do this, SimStudent 101 first includes all of the inserted subcells as candidate percepts, and calls the operator function sequence learner 122 to find an operator function sequence that explains all of the training examples. For example, the operator function sequence for (divide −3) would contain one operator function “divide”, since −3 is already included in the candidate percept list. The perceptual learner 118 then removes all of the subcells that are not used by the operator function sequence from the candidate percept list. Hence, subcells such as −, 3 and x would not be included in the percept list any more. Since all of the training example action records share the same operator function sequence, the number of percepts remaining for each example action record should be the same. Next, the percept learner 118 arranges the remaining subcell percepts based on their order of being used by the operator function sequences. After this process, the percept learner 118 now has a set of percept lists that contains a fixed number of percepts ordered in the same fashion. The original percept learner can be used to find the least general paths for the updated percept lists. In the example for skill “divide”, as shown by the extended production rule 604 of FIG. 6, the perceptual information part of the production rule 604 would contain three elements, the left-hand side and right-hand side cells which are the same as the original rule, and a coefficient subcell which corresponds to the left child of the variable term. Note that since the redundant subcells we removed, the acquired production rule now works with both −3x=6 and 4x=8.

In addition to extending the representation learning component 110, the vocabulary of feature symbols provided to the feature test learner 120 was also extended. The representation learning component 110 acquires information that reveal essential features of the problem state. These deep features can be used in describing desired situations to fire a production rule. Therefore, a set of grammar features that are associated with the acquired pCFG can be constructed. The set of new predicates describe positions of a subcell in the parse tree. For example, a new predicate called “is-left-child-of” was created, which should be true for (is-left-child-of −3 −3x) based on the parse tree shown in FIG. 4. These new predicates are not domain-specific (although they may be specific to the pCFG-based approach to deep feature learning). All of the grammar feature predicates are then included in the set of existing feature predicates for the feature test learner 120 to use later.

As another example, SimStudent can solve problems in stoichiometry. Stoichiometry is a branch of chemistry that deals with the relative quantities of reactants and products in chemical reactions. In the stoichiometry domain, SimStudent can be asked to solve problems such as “How many moles of atomic oxygen (O) are in 250 grams of P₄O₁₀? (Hint: the molecular weight of P₄O₁₀ is 283.88g P₄O₁₀/mol P₄O₁₀)”.

During the learning process, given the current state of the problem (e.g., 1 mol COH₄ has ? mol H), SimStudent first tries to propose a plan for the next step (e.g., (bind ?element (get-substance “? mol H”)) (bind ?output (molecular-ratio “1 mol COH₄” ?element))) based on the skill knowledge it has acquired. If it finds a plan and receives positive feedback, it continues to the next step. If the proposed next step is incorrect, the tutor sends negative feedback to SimStudent and demonstrates a correct next step. Then, SimStudent attempts to learn or modify its skill knowledge accordingly. If it has not learned enough skill knowledge and fails to find a plan, a correct next step is directly demonstrated to SimStudent. Based on the demonstration, SimStudent learns a set of production rules as its skill knowledge.

A production rule indicates “where” to look for information in the interface, “how” to change the problem state, and “when” to apply a rule. For example, the rule to “calculate how many moles of H are in 1 mole of COH₄” would be read as “given the current value (1 mol COH₄) and the question (? mol H), when the substance in question (H) is an element in the substance (COH₄), then get the substance in question (H), and compute the molecular ratio of H (4 mol H) in COH₄”.

To learn the “how” part in the production rules, SimStudent requires a set of operator functions given as prior knowledge. For instance, (molecular-ratio ?val1 ?val2) is an operator function. It generates the number of moles of an individual substance that each mole of input substance has, based on molecular ratio of input substance. There are two groups of operator functions: domain-specific operator functions (e.g., (molecular-ratio ?val1 ?val2)) and domain-general operator functions (e.g., (copy-string ?val)).

Many of the domain-specific operator functions are extraction operators that extract deep features from the input. In order to reduce SimStudent's dependence on such domain-specific operator functions, a representation learning component is used to acquire the deep features automatically, and then extend the “where” (perceptual information) part to include these deep features as needed. In addition to the original current value “1 mol COM” and the question “? mol H”, SimStudent automatically adds the molecular ratio of H (4) into the perceptual information part. Then, the “how” (operator sequence) part does not need the three domain-specific operators any more. Instead, SimStudent can directly concatenate the molecular ratio (4) with the rest part in question (mol H).

Another example that demonstrates how the extended “where” part enables the removal of domain-specific operator functions, while maintaining efficient skill knowledge acquisition can be shown using fraction addition. An operator function in this domain is getting the denominator of the addend (i.e., (get-denominator ?val)). FIG. 8 shows an example parse tree 800 for ⅗. The extended SimStudent can directly get the denominator 5 from the non-terminal symbol Number in rule M0→1.0, DivSign, Number. Then, the operator function (get-denominator ?val) is replaced by a more general operator function (copystring ?val). Another important domain-specific operator function in equation solving is getting the coefficient of some expression (i.e., (get-coefficient ?val)). With the representation learning component, the coefficient of an expression can be extracted by directly taking the signed number (i.e., SignedNumber) in rule Expression→1.0, SignedNumber, Variable. Again, the domain-specific operator function (get-coefficient ?val) is replaced by the domain-general operator function (copy-string ?val).

As mentioned before, (molecular-ratio ?val0 ?vall) is a domain-specific operator function used in stoichiometry. Instead of programming this operator function, after integrated with representation learning component, the output can now be generated by taking the Number in grammar rule E0→0. 5 Element, Number as shown in the example parse tree 900 of FIG. 9, and then concatenating with the unit mol and the individual substance Element. Thus, the original operator function (molecular-ratio ?val0 ?val1) is replaced by the domain-general operator function concatenation (i.e., (concat ?val2 ?val3)).

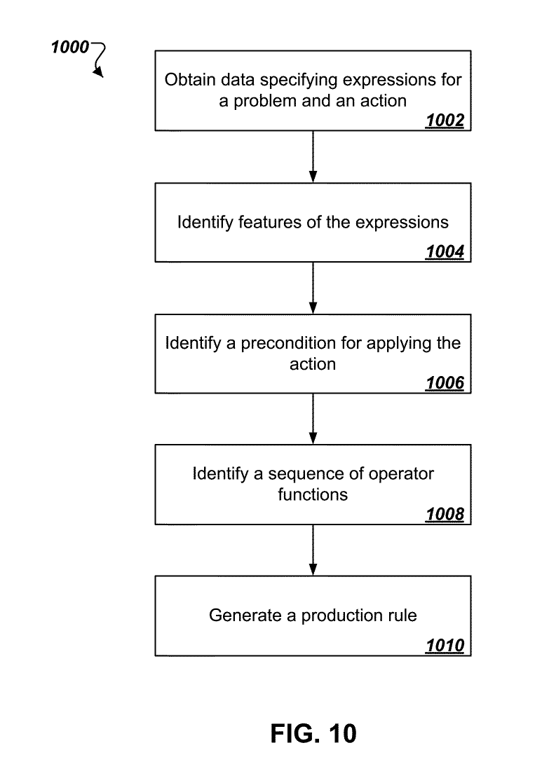

FIG. 10 is a flowchart of an example of a process 1000 for generating a production rule. The process 1000 may be performed by a system of one or more computers, such as SimStudent 101 of FIG. 1. The process 1000 may include details that have been discussed above.

The system obtains data specifying expressions for a problem to be solved and an action that changes a state of the problem when applied to the expressions (1002).

The system identifies features of the expressions (1004). The system may identify the features based on stored grammar rules and features of stored positive training problems that are associated with positive feedback. The system may identify features by generating a parse tree for an expression using the stored grammar rules. The parse tree can include nodes for respective features of the expression. The system may identify the features of the expressions based on the generated parse tree. The system may identify an intermediate symbol in a rule set of a probabilistic context free grammar. The intermediate symbol may correspond to a highest number of the stored positive training problems. The system may extract the one or more features associated with the intermediate symbol.

The system identifies a precondition for applying the action that changes the state of the problem (1006). The system may identify the precondition based on the positive training problems, negative training problems associated with negative feedback, and the identified features of the expressions. The system may identify the precondition based on positions of the nodes for the respective features of the expression.

The system identifies a sequence of operator functions (1008). The system may identify the sequence of operator function based on the identified features, the action that changes the state of the problem, and the positive training problems. The system may identify the sequence of operator functions by searching for a composed sequence of operator functions from a stored set of operator functions using iterative-deepening depth-first search. The system may search for the composed sequence of operator functions that has the smallest number of operator functions that includes the identified features and the action that changes the state of the problem.

The system generates a production rule (1010). The system may generate the production rule based on the identified features, the identified precondition, and the identified operator function. The production rule may include a set of tests pertaining to the identified one or more features for determining whether the precondition is satisfied.

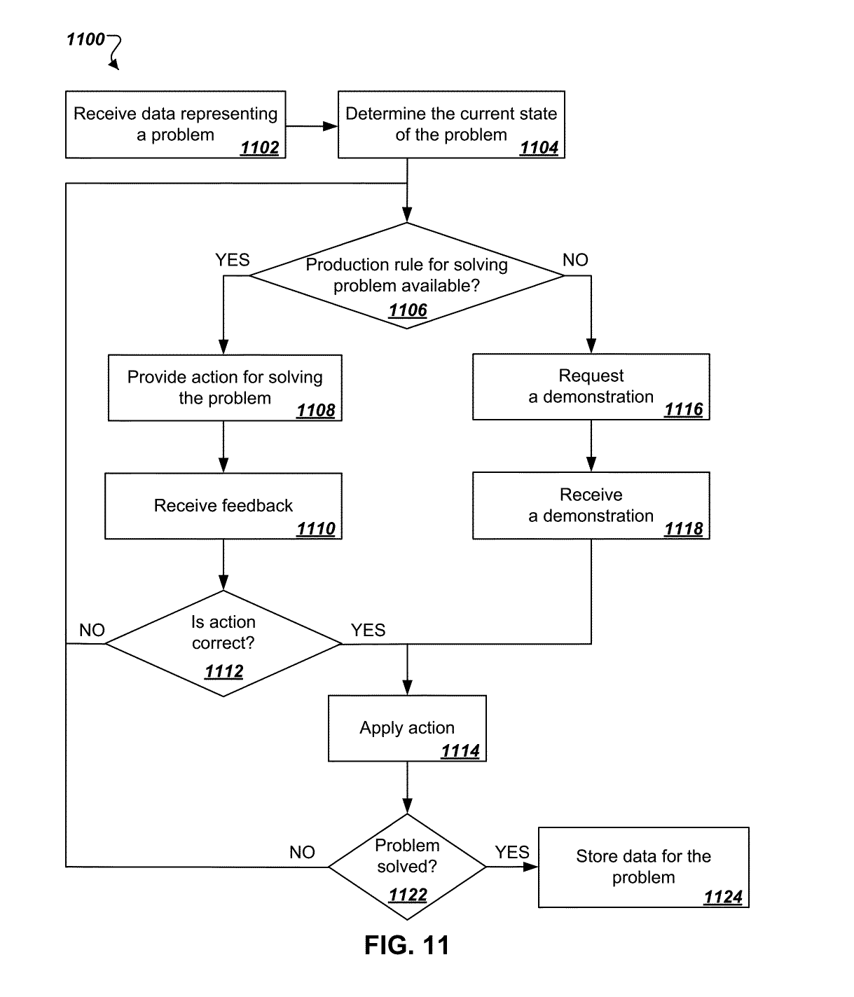

FIG. 11 is a flowchart of an example of a process 1100 for learning a production rule. The process 1100 may be performed by a system of one or more computers, such as SimStudent 101 of FIG. 1. The process 1100 may include details that have been discussed above.

The system receives data representing a problem (1102). The system determines the current state of the problem (1104). The system determines whether a production rule from a stored set of production rules is available for solving the problem based on the current state of the problem (1106).

If a production rule is available, the system provides a proposed action for solving the problem based on the identified production rule (1108). The system receives feedback (1110) indicating that the proposed action is correct or incorrect for solving the other problem (1112). If the proposed action is correct, the system applies the action to advance the state of the problem (1114). If the proposed action is incorrect, the system determines whether another production rule is available for solving the problem (1106).

If a production rule is not available, the system requests a demonstration of the action for solving the problem (1116). The system receives the demonstration of the action (1118) and applies the action to the problem to advance the state of the problem (1114). The system determines whether the problem is solved (1122). If the problem is not solved, the system determines whether another production rule is available for solving the problem (1106).

When the problem is solved, the system stores data for the problem (1124). If the system received positive feedback indicating that the proposed action is correct, the system stores data indicating that the problem is a positive training example. If the system received negative feedback indicating that the proposed action is incorrect, the system stores data indicating that the problem is a negative training example. The stored includes the current state of the problem and the proposed action corresponding to feedback. If a demonstration was provided, the system generates a production rule corresponding to the demonstration and stores the production rule.

Student modeling is a factor that may affect automated tutoring systems in making instructional decisions. A student model is a model to predict the probability of a student making errors on given problems. A student model that matches with student behavior patterns may provide useful information on learning task difficulty and transfer of learning between related problems, and thus may yield better instruction. Manual construction of such models may require substantial human effort, and may miss distinctions in content and learning that may have important instructional implications.

SimStudent can be used to automatically discover student models and construct cognitive models for intelligent tutoring systems with less dependence on human-provided factors. The cognitive model provides important information to automated tutoring systems in making instructional decisions. Better cognitive models match with real student learning behavior. They are capable of predicting task difficulty and transfer of learning between related problems, and can be used to yield better instruction.

A cognitive model can be represented using a set of knowledge components (KC) that are encoded in intelligent tutors to model how students solve problems. The set of KCs includes the component skills, concepts, or percepts that a student must acquire to be successful on the target tasks. For example, a KC in algebra can be how students should proceed given problems of the form Nv=N (e.g., −3x=6). Each production rule corresponds to a KC that students need to learn. The model then labels each observation of a real student based on skill application.

To generate the SimStudent model, SimStudent is tutored on how to solve problems by interacting with an automated tutor. As the training set for SimStudent, problems that were used to teach real students may be selected. Given all of the acquired production rules, for each step a real student performed, the applicable production rule may be assigned as the KC associated with that step. In cases where there was no applicable production rule, the step can be coded using a human-generated KC model.

The resulting SimStudent model may contain 21 KCs. Among the 21 KCs learned by the SimStudent model, there may be 17 transformation KCs (a skill to identify an appropriate basic operator) and four typein KCs (a skill to actually execute the basic operator). The transformation skills associated with the basic arithmetic operators (i.e. add, subtract, multiply and divide) are further split into finer grain sizes based on different problem forms.

One example of such split is two KCs for division. The first KC (simSt-divide) corresponds to problems of the form Ax=B, where both A and B are signed numbers, whereas the second KC (simSt-divide-1) is specifically associated with problems of the form −x=A, where A is a signed number. This is caused by the different parse trees for Ax vs −x. To solve Ax=B, SimStudent may divide both sides with the signed number A. On the other hand, since −x does not have −1 represented explicitly in the parse tree, SimStudent needs to see −x as −1x, and then to extract −1 as the coeffcient. If SimStudent is a good model of human learning, the same is true for human students. That is, real students should have greater difficulty in making the correct move on steps like −x=6 than on steps like −3x=6 because of the need to convert (perhaps just mentally) −x to −1x. SimStudent's split of the original division KC into two KCs, simSt-divide and simSt-divide-1, suggests that the tutor should teach real students to solve two types of division problems separately. In other words, when tutoring students with division problems, two subsets of problems may be included, one subset corresponding to simSt-divide problems (Ax=B), and one specifically for simSt-divide-1 problems (−x=A). Explicit instruction that highlights for students that −x is the same as −1x may also be included.

The basic idea is to have SimStudent learn to solve the same problems as human students and use the production rules that SimStudent generates as knowledge components to codify problem-solving steps. Then these KC coded steps can be used to validate the models prediction. Unlike a human-engineered student model, the SimStudent generated student model has a clear connection between the features of the domain contents and knowledge components. An advantage of the SimStudent approach of student modeling over previous techniques is that it does not depend heavily on the human-engineered features. SimStudent can automatically discover a need to split a purported KC or skill into more than one skill. During SimStudents learning, a failure of generalization for a particular KC results in learning disjunctive rules. Discovering such disjuncts is equivalent to splitting a KC, but where a human would traditionally provide potential factors as the basis for a possible split, SimStudent can learn such factors.

The evaluation demonstrated that representing the rules SimStudent learns in the student model improves the accuracy of model prediction, and showed how the SimStudent model could provide important instructional implications. Much of human expertise is only tacitly known. For instance, we know the grammar of our first language but do not know what we know. Similarly, most algebra experts have no explicit awareness of subtle transformations they have acquired like the one above (seeing −x as −1x). Even though such instructional designers may be experts in a domain they may have some blind spots regarding subtle perceptual differences like this one, which may make a real difference for novice learners. A machine learning agent, like SimStudent, can help get past such blind spots by revealing challenges in the learning process that experts may not be aware of

It is yet a further aspect of the present disclosure to provide a system which provides interleaved problem orders. A variable that affects learning effectiveness is the order of problems presented to students. While most existing textbooks organize problems in a blocked order, in which all problems of one type (e.g., learning to solve equations of the form S₁/V=S2) are completed before the student is switched to the next problem type, problems in an interleaved order may yield more effective learning.

In the fraction addition domain, fraction addition problems can be of the form

$$\frac{{numerator}_{1}}{{denominator}_{1}} + \frac{{numerator}_{2}}{{denominator}_{2}}$$

where the numerators and denominators are positive integers. The problems can be of three types in the order of increasing difficulty:
1. Easy problems, where the two addends share the same denominators (i.e., denominator 1=denominator 2, e.g., ¼+¾).
2. Medium problems, where one denominator is a multiple of the other denominator (i.e., greatest common denominator (GCD)(denominator 1, denominator 2)=denominator 1 or denominator 2, e.g., ½+¾).
3. Hard problems, where no denominator is a multiple of the other denominator (e.g., ⅓+¾). In this case, students need to find the common denominator (e.g., 12 for ⅓+¾) by themselves.

Equation solving may be a more challenging domain since it requires more complicated prior knowledge to solve the problem. For example, it may be difficult for human students to learn what a coefficient is, and what a constant is. Also, adding two terms together may be more complicated than adding two numbers. In the equation solving domain, the problems can be of three types:

1. Problems of the form S₁+S₂ V=S₃,

2. Problems of the form V/S₁=S₂,

3. Problems of the form S₁/V=S₂,

where S₁ and S₂ are signed numbers, and V is a variable. Note that the terms in the above problem forms can appear in any order, and may be surrounded with parenthesis.

In a chemistry domain such as stoichiometry, which a branch of chemistry that deals with the relative quantities of reactants and products in chemical reactions, a problem may be, for example, “How many moles of atomic oxygen (O) are in 250 grams of P₄O₁₀? (Hint: the molecular weight of P₄O₁₀ is 283.88 g P₄O₁₀/mol P₄O₁₀.)”. In stoichiometry, the problems can be of three types:
1. Unit conversion (e.g., 0.6 kg H₂O=600 g H₂O). An example of a type 1 problem is “How many grams (g) are in 10.6 milligrams (mg) of wood alcohol (COH₄)?”.
2. Molecular weight (e.g., There are 2 moles of P₄O₁₀ in 283.88×2 g P₄O₁₀). An example of a type 2 problem is “What is the number of moles of alcohol/kg of H₂O in a solution of 6.00 g COH₄ in 100.0 g of H₂O? (Hint: the molecular weight of COH₄ is 32.04 g COH₄/mol of COH₄)”.
3. Composition stoichiometry (e.g., There are 10 moles of O in each mole of P₄O₁₀). An example of a type 3 problem is “How many grams of Ba are in exactly 3.00 moles of YBa₂Cu₃O₇ (a superconductor)? (Hint: the molecular weight of Ba is 137.33 g Ba/mol Ba.)”.

The three domains represent skill knowledge of different types. The problems described above are ordered in increasing difficulty, where each later type adds one more skill comparing with the earlier type. In the fraction addition domain, the production rules of higher order are more general and can replace the production rules of lower order (i.e., the production rules acquired from problems of type 3 are enough to solve the problem in every case). In the equation solving domain, some production rules acquired from one type of problems are separate from the other production rules and can only be applied to this specific type of problems. In the stoichiometry domain, production rules learned from problems of lower order can be used to partially solve problems of higher order, but new production rules need to be acquired to solve problems of higher order. The different nature of the three domains may present different challenges to the “when” part and “how” part learning. This difference may cause distinctive behaviors of SimStudent in the learning procedure. For example, in fraction addition, the key to success of learning may be the “how” part learning. On the contrary, in the other two domains, “when” part learning may be more essential in the learning procedure than the “how” part learning. Despite the differences among the domains, interleaved-order curricula may yield more effective learning than blocked-order curricula across these three domains.

To manipulate the order of problems given to SimStudent, for each domain, the problems of the same type were first grouped together. Since there were three types of problems, there were three groups in each domain: group1, group2, and group3. Although textbooks often start with easier problems followed by hard problems, to carry out a more extensive study, it also included curricula that start with harder problems. There were six different orders of these three groups. For each order (e.g., [group1, group2, group3]), one blocked-ordering curriculum was generated by repeating the same problems in each group right after that group's training was done (e.g., [group1, group1′, group2, group2′, group3, group3′]). To generate the interleaved-ordering curriculum, the same problems will be repeated once the whole set of problems were done (e.g, [group 1, group2, group3, group1′, group2′, group3′]). For example, in the fraction addition domain, the blocked order curriculum would be of the form [¼+¾, ¼+¾, ½+¾, ½+¾, ⅓+¾, ⅓+¾], but with more problems. For the interleaved order curriculum, the problems would be shown in the order [¼+¾, ½+¾, ⅓+¾, ¼+¾, ½+¾, ⅓+¾]. Since the problems were repeated in different orders, the total number of training problems shown to SimStudent is double of the number of the original training problems given to human students.

After this manipulation, there were 12 curricula of different orders for each domain. Six of them were blocked-ordering curricula, whereas the other six were interleaved-ordering curricula. SimStudent may be trained on all these curricula, and tested by the set of testing problems. In the training phase, the current set of production rules SimStudent acquires every time SimStudent finishes a new training problem may be recorded. Then, in the testing phase, the sequence of production rule sets by all of the testing problems may be tested.

To measure learning gain, the production rules learned by SimStudent may be evaluated on the set of testing problems. More specifically, during the training phase, SimStudent may record the production rules it learns. Then, SimStudent may be asked to solve problems in the test phase without resorting to any external help. In math and science problems, there may be more than one way to solve one problem. Hence, at each step, there may be more than one production rule that is applicable. Using the knowledge it acquired in the training phase, SimStudent may propose all possible next steps in solving the problem.

When problems are of an interleaved order, SimStudent may incorrectly apply the production rules learned from previous problem types to the current problem, even if the current problem is of another type. In this case, SimStudent receives explicit negative feedback from the tutor. In contrast, when trained on blocked-ordering curricula, SimStudent has fewer opportunities for incorrect rule applications, and thus receives less negative feedback. Since the negative feedback serves as negative training examples of the “when” learning, more negative feedback in the interleaved problem order case may enable SimStudent to yield more effective “when” learning compared to blocked problem orders.

For example, in stoichiometry, since the skill composition stoichiometry may be taught in problems of type three, if SimStudent was given the blocked-ordering curriculum [group1, group1′, group2, group2′, group3, group3′], all of the negative examples explained for composition stoichiometry production rules may be from problems of type three. For example, one of the skills, which decides O is a substance in P₄O₁₀ and outputs 1 mol P₄O₁₀, may not receive any negative feedback, since it works as originally acquired throughout group3 and group3′. In this case, the “when” part of the acquired skill may be empty, which considers all situations applicable to the skill, and thus the skill may be overly general. When given the interleaved-ordering curriculum [group1, group2, group3, group1′, group2′, group3′], SimStudent may incorrectly apply this composition stoichiometry skill to problems that need unit conversion (in group1′). Given the problem of how many grams (g) of COH₄ are in 10.6 mg COH₄, SimStudent may return 1 mg COH₄, which was incorrect. Given this negative feedback, SimStudent may update its overly general production rule, and learned that to apply this composition stoichiometry rule, the unit of the given value (e.g., mg) and the targeted unit (e.g., g) should not be convertible.

Negative examples from other problem types, which may be experienced more often in interleaved ordering, may be more informative than those from the same problem type. For example, during the acquisition of the skill “subtract” in equation solving, SimStudent given blocked-ordering problems may be first trained in groupl to solve problems of the form S₁V+S₂=S₃. SimStudent may learn that when there is a constant term in the left-hand side of the equation (e.g., term S₂ is a number in S₁ V+S₂=S₃), subtract both sides with that number (e.g., (subtract S₂)). But it may fail to learn that there must be more than one term in the left-hand side connected by a plus sign (e.g., S₁ V+S2). In the interleaved condition, SimStudent may receive negative feedback from problems of group3 (i.e., problems of the form S₁=S₂/V). SimStudent may try to subtract both sides with S₁ when given problems of type S₁=S₂/V. SimStudent given interleaved-ordering problems may modify its “when” part when given negative feedback on such problems. The updated production rule may become “when there is a constant term that follows a plus sign in the left-hand side of the equation, subtract both sides with that number.”

Since this negative feedback may be given to SimStudent earlier in the training process, SimStudent may acquire the skill knowledge faster than the one given the blocked-ordering curriculum. Thus, in the following problems, the SimStudent given the interleaved-ordering curriculum may receive less negative feedback than the SimStudent given the blocked-ordering curriculum, and may have a faster learning curve.

Unlike the two other domains, SimStudent in fraction addition may not have to learn different sets of skills to solve problems of different types. Instead, SimStudent learns one set of rules that handles fraction addition problems of all types. Thus, “when” learning may be less essential in achieving effective learning in this domain. Suppose SimStudent was trained on the blocked-ordering curriculum [group3, group3′, group2, group2′, group1, group1′]. From being trained on problems of type 3 (e.g., ⅖+⅓), SimStudent may learn that it should first calculate the least common multiple of the two denominators of the addends, and then covert the fractions to get the answer. This set of skills may also apply to problems of type 1 (e.g., ½+½) and 2 (e.g., ½+¾). Therefore, no negative feedback may be needed. The interleaved-ordering curriculum may be no more beneficial than the blocked-ordering curriculum. In cases where a more general strategy invokes a more complicated procedure (like calculating the common denominators), human students may prefer to use a less general but simple strategy (such as directly copying the addend's denominator). A conflict resolution strategy has been developed which could be used to prefer skills of smaller computational cost. This extension potentially addresses this limitation of SimStudent as a student model.

An implementation of SimStudent could have memory (or retrieval) limitations (e.g., it remembers all past examples no matter how long ago). For example, it would need to have some memory limitations if it were to have a bigger knowledge base or to better model humans. If it did, the benefits for blocking may go up, and in particular for “how” learning. There are different models of memory limitations. To see how memory limitation changes the behavior of SimStudent, consider a fixed memory size for SimStudent, which means SimStudent is only able to remember a fixed number of most recent training examples. SimStudent receives positive training examples of “how” learning only when the current step is demonstrated or SimStudent applies a production rule correctly. Hence, in the blocked problem order case, SimStudent maintains all the training examples of the current problem type unless the number of training examples exceeds the memory limit. In contrast, when trained on interleaved-ordering curricula, SimStudent needs to remember training examples for multiple problem types. For any specific production rule, the number of stored training examples within the threshold will be smaller than that given a blocked-ordering curricula, which could result in less effective learning than the blocked-ordering case. Therefore, theoretical results may change when memory limitations are modeled.

“When” learning, on the other hand, may not be affected as much by memory limitations because of a different inductive bias. “When” learning starts with the most general condition and makes the condition more specific when negative examples are received. In contrast, function operator sequence (how) learning is driven by positive examples and will create more complex sequences only when multiple positive examples are received. If a subprocedure is achieved in the same way, that is, with the same “how” part in the production rule, problems of blocked orders may be more beneficial. However, for production rules/procedures to differentiate across subgoals, the “when” part may need to be acquired and in that case, interleaving problems of different types may be important.

In summary, learning when to apply a skill may benefit more from interleaved problem orders. Also, learning how to apply a skill may benefit more from blocked problem orders. “When” learning may be more challenging in the equation solving and stoichiometry domains, while “how” learning may be more essential in the fraction addition domain. Therefore, when tutoring students in domains that are more challenging in “how” learning, SimStudent may present the problems to students starting with more blocked orders. If the learning task requires more rigorous “when” learning, SimStudent may present interleaved-ordered problems.

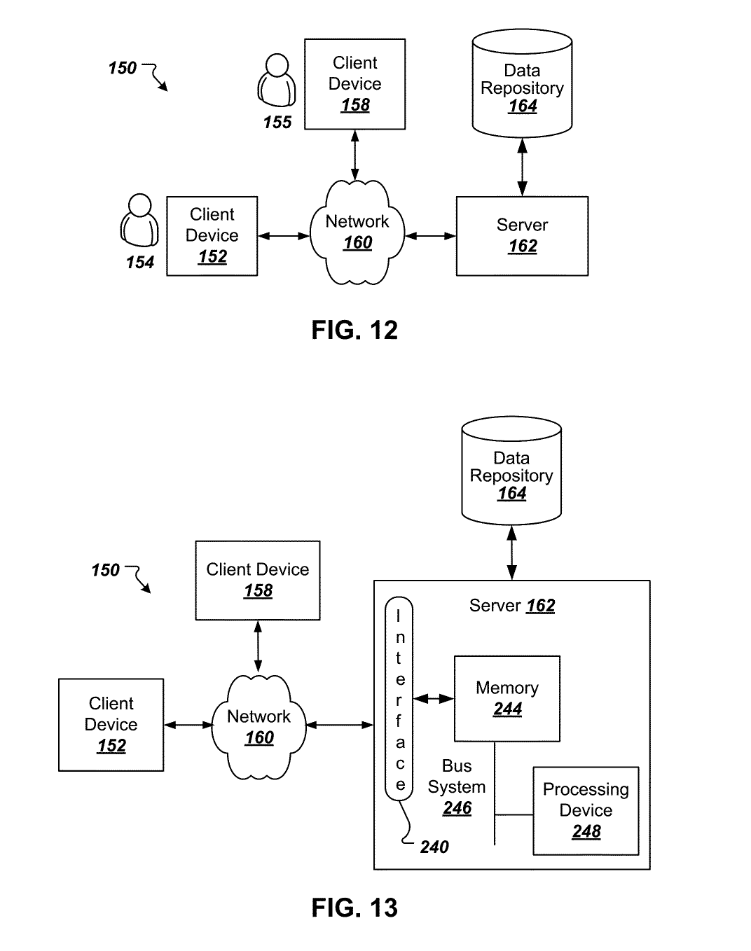

FIG. 12 is a block diagram of an example of a network environment 150 including an intelligent system. Network environment 150 includes client devices 152 and 158, network 160, server 162, and data repository 164.

The client device 152 is used by a user 154, such as a non-expert programmer. The client device 158 is used by user 155, such as a student. The client devices 152, 158 may present graphical user interfaces to the users 154, 155 on a display device of the client devices 152, 158. The users 154, 155 may use the client devices 152, 158 to provide input and feedback to the intelligent system. The client devices 152, 158 sends the input and feedback to the server 162. The server 162 may store the input, feedback, and production rules in a data repository 164.

The server 162 may be a system that includes the intelligent system. The server 162 may retrieve production rules from the data repository 164 and provide the production rules to a user.

FIG. 13 is a block diagram of examples of components of the network environment 150 of FIG. 12. In FIG. 13, the client devices 152 and 158 can be any sort of computing devices capable of taking input from a user and communicating over network 160 with server 162 and/or with other client devices. For example, the client devices 152 and 158 can be mobile devices, desktop computers, laptops, cell phones, personal digital assistants (“PDAs”), servers, embedded computing systems, and so forth.

Server 162 can be any of a variety of computing devices capable of receiving data, such as a server, a distributed computing system, a desktop computer, a laptop, a cell phone, a rack-mounted server, and so forth. Server 162 may be a single server or a group of servers that are at a same location or at different locations.

The illustrated server 162 can receive data from the client devices 152 and 158 via input/output (“I/O”) interface 240. I/O interface 240 can be any type of interface capable of receiving data over a network, such as an Ethernet interface, a wireless networking interface, a fiber-optic networking interface, a modem, and so forth. Server 162 also includes a processing device 248 and memory 244. A bus system 246, including, for example, a data bus and a motherboard, can be used to establish and to control data communication between the components of server 212.

The illustrated processing device 248 may include one or more microprocessors. Generally, processing device 248 may include any appropriate processor and/or logic that is capable of receiving and storing data, and of communicating over a network (not shown). Memory 244 can include a hard drive and a random access memory storage device, such as a dynamic random access memory, or other types of non-transitory machine-readable storage devices. Memory 244 stores computer programs (not shown) that are executable by processing device 248 to perform the techniques described herein.

Embodiments can be implemented in digital electronic circuitry, or in computer hardware, firmware, software, or in combinations thereof. An apparatus can be implemented in a computer program product tangibly embodied or stored in a machine-readable storage device for execution by a programmable processor; and method actions can be performed by a programmable processor executing a program of instructions to perform functions by operating on input data and generating output. The embodiments described herein, and other embodiments of the invention, can be implemented advantageously in one or more computer programs that are executable on a programmable system including at least one programmable processor coupled to receive data and instructions from, and to transmit data and instructions to, a data storage system, at least one input device, and at least one output device. Each computer program can be implemented in a high-level procedural or object oriented programming language, or in assembly or machine language if desired; and in any case, the language can be a compiled or interpreted language.

Processors suitable for the execution of a computer program include, by way of example, both general and special purpose microprocessors, and any one or more processors of any kind of digital computer. Generally, a processor will receive instructions and data from a read-only memory or a random-access memory or both. The essential elements of a computer are a processor for executing instructions and one or more memory devices for storing instructions and data. Generally, a computer will also include, or be operatively coupled to receive data from or transfer data to, or both, one or more mass storage devices for storing data, e.g., magnetic, magneto optical disks, or optical disks. Computer readable media for embodying computer program instructions and data include all forms of non-volatile memory, including by way of example semiconductor memory devices, e.g., EPROM, EEPROM, and flash memory devices; magnetic disks, e.g., internal hard disks or removable disks; magneto optical disks; and CD ROM and DVD-ROM disks. The processor and the memory can be supplemented by, or incorporated in special purpose logic circuitry. Any of the foregoing can be supplemented by, or incorporated in, ASICs (application-specific integrated circuits).

To provide for interaction with a user, embodiments can be implemented on a computer having a display device, e.g., a LCD (liquid crystal display) monitor, for displaying data to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input.

Embodiments can be implemented in a computing system that includes a back end component, e.g., as a data server, or that includes a middleware component, e.g., an application server, or that includes a front end component, e.g., a client computer having a graphical user interface or a Web browser through which a user can interact with an implementation of embodiments, or any combination of such back end, middleware, or front end components. The components of the system can be interconnected by any form or medium of digital data communication, e.g., a communication network. Examples of communication networks include a local area network (LAN) and a wide area network (WAN), e.g., the Internet.

The system and method or parts thereof may use the “World Wide Web” (Web or WWW), which is that collection of servers on the Internet that utilize the Hypertext Transfer Protocol (HTTP). HTTP is a known application protocol that provides users access to resources, which may be data in different formats such as text, graphics, images, sound, video, Hypertext Markup Language (HTML), as well as programs. Upon specification of a link by the user, the client computer makes a TCP/IP request to a Web server and receives data, which may be another Web page that is formatted according to HTML. Users can also access other pages on the same or other servers by following instructions on the screen, entering certain data, or clicking on selected icons. It should also be noted that any type of selection device known to those skilled in the art, such as check boxes, drop-down boxes, and the like, may be used for embodiments using web pages to allow a user to select options for a given component. Servers run on a variety of platforms, including UNIX machines, although other platforms, such as Windows 2000/2003, Windows NT, Windows 7, Windows 8, Sun, Linux, and Macintosh may also be used. Computer users can view data available on servers or networks on the Web through the use of browsing software, such as Firefox, Netscape Navigator, Microsoft Internet Explorer, or Mosaic browsers. The computing system can include clients and servers. A client and server are generally remote from each other and typically interact through a communication network. The relationship of client and server arises by virtue of computer programs running on the respective computers and having a client-server relationship to each other.

Other embodiments are within the scope and spirit of the description claims. Additionally, due to the nature of software, functions described above can be implemented using software, hardware, firmware, hardwiring, or combinations of any of these. Features implementing functions may also be physically located at various positions, including being distributed such that portions of functions are implemented at different physical locations. The use of the term “a” herein and throughout the application is not used in a limiting manner and therefore is not meant to exclude a multiple meaning or a “one or more” meaning for the term “a.” Additionally, to the extent priority is claimed to a provisional patent application, it should be understood that the provisional patent application is not limiting but includes examples of how the techniques described herein may be implemented.

A number of exemplary embodiments of the invention have been described. Nevertheless, it will be understood by one of ordinary skill in the art that various modifications may be made without departing from the spirit and scope of the invention.

What is claimed is:

1. A method comprising:
obtaining data specifying one or more expressions for a problem to be solved and an action that changes a state of the problem when applied to the one or more expressions;
identifying, by one or more processors, one or more features of the one or more expressions based on stored grammar rules and further based on features of stored positive training problems that are associated with positive feedback;
identifying, by the one or more processors, a precondition for applying the action that changes the state of the problem, with identification of the precondition based on the positive training problems, negative training problems associated with negative feedback, and the identified one or more features of the one or more expressions;
identifying, by the one or more processors, a sequence of operator functions based on the identified one or more features, the action that changes the state of the problem, and the positive training problems; and
generating, by the one or more processors, a production rule based on the identified one or more features, the identified precondition, and the identified operator function.

2. The method of claim 1, wherein the problem to be solved is in a math, science, or language learning domain.

3. The method of claim 1, wherein identifying the one or more features of the one or more expressions based on the stored grammar rules comprises:
generating a parse tree for an expression using the stored grammar rules, with the parse tree comprising one or more nodes for one or more respective features of the expression; and
identifying the one or more features of the one or more expressions based on the generated parse tree.

4. The method of claim 3, wherein identifying the precondition based on the identified one or more features of the one or more expressions comprises:
identifying the precondition based on positions of the one or more nodes for the one or more respective features of the expression.

5. The method of claim 1, wherein identifying the one or more features of the one or more expressions based on the stored grammar rules and the features of the stored positive training problems comprises:
identifying an intermediate symbol in a rule set of a probabilistic context free grammar, the intermediate symbol corresponding to a highest number of the stored positive training problems; and
extracting the one or more features associated with the intermediate symbol.

6. The method of claim 1, wherein identifying the sequence of operator functions comprises:
searching for a composed sequence of operator functions from a stored set of operator functions using iterative-deepening depth-first search to identify the composed sequence of operator functions that has a smallest number of operator functions that includes the identified one or more features and the action that changes the state of the problem.

7. The method of claim 1, wherein generating the production rule based on the identified precondition comprises:
generating a set of tests pertaining to the identified one or more features for determining whether the precondition is satisfied.

8. The method of claim 1, further comprising:
determining a current state of another problem;
identifying the generated production rule from a stored set of production rules based on the current state of the other problem; and
providing a proposed action for solving the other problem based on the generated production rule.

9. The method of claim 8, further comprising:
receiving feedback indicating that the proposed action is correct for solving the other problem; and
storing the current state and the proposed action as a positive training problem.

10. The method of claim 8, further comprising:
receiving feedback indicating that the proposed action is incorrect for solving the other problem; and
storing the current state and the proposed action as a negative training problem.

11. A system comprising:
one or more processing devices; and
one or more computer-readable media storing instructions that are executable by the one or more processing devices to perform operations comprising:
obtaining data specifying one or more expressions for a problem to be solved and an action that changes a state of the problem when applied to the one or more expressions;
identifying, by one or more processors, one or more features of the one or more expressions based on stored grammar rules and further based on features of stored positive training problems that are associated with positive feedback;
identifying, by the one or more processors, a precondition for applying the action that changes the state of the problem, with identification of the precondition based on the positive training problems, negative training problems associated with negative feedback, and the identified one or more features of the one or more expressions;
identifying, by the one or more processors, a sequence of operator functions based on the identified one or more features, the action that changes the state of the problem, and the positive training problems; and
generating, by the one or more processors, a production rule based on the identified one or more features, the identified precondition, and the identified operator function.

12. The system of claim 11, wherein the problem to be solved is in a math, science, or language learning domain.

13. The system of claim 11, wherein identifying the one or more features of the one or more expressions based on the stored grammar rules comprises:
generating a parse tree for an expression using the stored grammar rules, with the parse tree comprising one or more nodes for one or more respective features of the expression; and
identifying the one or more features of the one or more expressions based on the generated parse tree.

14. The system of claim 13, wherein identifying the precondition based on the identified one or more features of the one or more expressions comprises:
identifying the precondition based on positions of the one or more nodes for the one or more respective features of the expression.

15. The system of claim 11, wherein identifying the one or more features of the one or more expressions based on the stored grammar rules and the features of the stored positive training problems comprises:
identifying an intermediate symbol in a rule set of a probabilistic context free grammar, the intermediate symbol corresponding to a highest number of the stored positive training problems; and
extracting the one or more features associated with the intermediate symbol.

16. The system of claim 11, wherein identifying the sequence of operator functions comprises:
searching for a composed sequence of operator functions from a stored set of operator functions using iterative-deepening depth-first search to identify the composed sequence of operator functions that has a smallest number of operator functions that includes the identified one or more features and the action that changes the state of the problem.

17. The system of claim 11, wherein generating the production rule based on the identified precondition comprises:
generating a set of tests pertaining to the identified one or more features for determining whether the precondition is satisfied.

18. The system of claim 11, wherein the operations further comprise:
determining a current state of another problem;
identifying the generated production rule from a stored set of production rules based on the current state of the other problem; and
providing a proposed action for solving the other problem based on the generated production rule.

19. The system of claim 18, wherein the operations further comprise:
receiving feedback indicating that the proposed action is correct for solving the other problem; and
storing the current state and the proposed action as a positive training problem.

20. The system of claim 18, wherein the operations further comprise:
receiving feedback indicating that the proposed action is incorrect for solving the other problem; and
storing the current state and the proposed action as a negative training problem.

21. One or more computer-readable media storing instructions that are executable by one or more processing devices to perform operations comprising:
obtaining data specifying one or more expressions for a problem to be solved and an action that changes a state of the problem when applied to the one or more expressions;
identifying, by one or more processors, one or more features of the one or more expressions based on stored grammar rules and further based on features of stored positive training problems that are associated with positive feedback;
identifying, by the one or more processors, a precondition for applying the action that changes the state of the problem, with identification of the precondition based on the positive training problems, negative training problems associated with negative feedback, and the identified one or more features of the one or more expressions;
identifying, by the one or more processors, a sequence of operator functions based on the identified one or more features, the action that changes the state of the problem, and the positive training problems; and
generating, by the one or more processors, a production rule based on the identified one or more features, the identified precondition, and the identified operator function.

22. The one or more computer-readable media of claim 21, wherein the problem to be solved is in a math, science, or language learning domain.

23. The one or more computer-readable media of claim 21, wherein identifying the one or more features of the one or more expressions based on the stored grammar rules comprises:
generating a parse tree for an expression using the stored grammar rules, with the parse tree comprising one or more nodes for one or more respective features of the expression; and
identifying the one or more features of the one or more expressions based on the generated parse tree.

24. The one or more computer-readable media of claim 23, wherein identifying the precondition based on the identified one or more features of the one or more expressions comprises:
identifying the precondition based on positions of the one or more nodes for the one or more respective features of the expression.

25. The one or more computer-readable media of claim 21, wherein identifying the one or more features of the one or more expressions based on the stored grammar rules and the features of the stored positive training problems comprises:
identifying an intermediate symbol in a rule set of a probabilistic context free grammar, the intermediate symbol corresponding to a highest number of the stored positive training problems; and
extracting the one or more features associated with the intermediate symbol.

26. The one or more computer-readable media of claim 21, wherein identifying the sequence of operator functions comprises:
searching for a composed sequence of operator functions from a stored set of operator functions using iterative-deepening depth-first search to identify the composed sequence of operator functions that has a smallest number of operator functions that includes the identified one or more features and the action that changes the state of the problem.

27. The one or more computer-readable media of claim 21, wherein generating the production rule based on the identified precondition comprises:
generating a set of tests pertaining to the identified one or more features for determining whether the precondition is satisfied.

28. The one or more computer-readable media of claim 21, wherein the operations further comprise:
determining a current state of another problem;
identifying the generated production rule from a stored set of production rules based on the current state of the other problem; and
providing a proposed action for solving the other problem based on the generated production rule.

29. The one or more computer-readable media of claim 28, wherein the operations further comprise:
receiving feedback indicating that the proposed action is correct for solving the other problem; and
storing the current state and the proposed action as a positive training problem.

30. The one or more computer-readable media of claim 28, wherein the operations further comprise:
receiving feedback indicating that the proposed action is incorrect for solving the other problem; and
storing the current state and the proposed action as a negative training problem.
